(19) United States
(12) Patent Application Publication
(10) Pub. No.: US 2014/0047310 A1
(43) Pub. Date: Feb. 13, 2014

(54) MOBILE DRILLDOWN VIEWER FOR STANDARDIZED DATA

(71) Applicant: Alexei Potiagalov, Richmond (CA)

(72) Inventor: Alexei Potiagalov, Richmond (CA)

(73) Assignee: BUSINESS OBJECTS SOFTWARE LTD., Dublin (IE)

(21) Appl. No.: 13/584,567

(22) Filed: Aug. 13, 2012

(51) Int. Cl. G06F 3/048; G06F 17/00

(52) U.S. Cl. 715/205

(57) ABSTRACT

Retrieving and displaying data from a remote data storage system on mobile computing devices via a user interface for browsing data stored on the data storage system. In response to a user selection of a dataset stored on the data storage system, a top level report grouping and summarizing the data of the selected dataset is displayed in which the top level report includes links for drilling down into one of the groups of data of the selected dataset. In response to a user selection of a link in the top level report, a lower level report grouping and summarizing the data of the group(s) corresponding to the selected link is displayed. The lower level report includes links for drilling down into the groups of data within the group(s) corresponding to the selected link and may also include links for drilling back up into the higher level data.

### BACKGROUND

There is a growing proliferation of smart phones and other mobile devices with small form factors and often with low resolution screens. For users of such devices, it is impractical to view complex and detailed data, such as business reports, in their entirety. For example, reading data in a table with 70 data rows on a 4-inch display would be extremely impractical without the use of an auxiliary output, e.g. connecting the mobile device to a desktop display.

Application programs that generate reports for viewing, such as financial reporting programs, may retrieve and/or access data from a data storage system through an application interface. The various available data storage systems have different data structures or formats for storing data and are not generally compatible with a single standard interface. Thus, application programs that interact with a specific one of these storage systems may have to use an application interface that is specifically configured to communicate with said specific data storage system.

An alternative solution is to convert the stored a standardized or formatted set of data requested by a data browsing application from a data storage system (e.g. an employee file) into a data format that is understood by the data browsing application. For example, SAP Content Report Format (CRF), which is an Extensible Markup Language (XML) document with the XML markups understood by SAP Mobile BI interface which has the ability to render “report content” provided in CRF format so that stored data converted to CRF format may be rendered or displayed via the SAP Mobile BI interface. Other formats which support object/content linking such as HyperText Markup Language (HTML) may also be used. In this way data may be retrieved from a particular data storage system by a data browsing application (running on a mobile device), which is configured to retrieve data from the particular data storage system (either directly or via another back-end application), and the data may then be converted (either directly or via another back-end application) to a format that may be used by the data browsing application to display the data (e.g. by generating reports based on the data) in a manner that facilitates viewing on modern mobile devices in view of the limitations of these mobile devices.

### SUMMARY OF THE INVENTION

The present invention addresses these and other problems and provides solutions in the form of a drill down report that is interactive and enhances the viewer's experience by initially providing only a summary of the overall information and then allowing the viewer to drill-down to the details that are of interest.

An application interface to retrieve information from a data storage system, for example a financial/business system or general ledger system, and display the data in a drill down manner starting with a top level summary of the full report. Data from a particular data storage system is retrieved and converted into a more generalized or system independent format. The interface is optimized for use with small mobile devices and allows a user to communicate with, or drill back to, the data storage system to retrieve detailed data as necessary after viewing the initial summary of the report.

The application which converts the data and presents it to a user of a mobile device in an interface that is optimized for small form factor mobile devices may either run on a server/computer that the mobile device may connect to or it may run on the mobile device itself.

### BRIEF DESCRIPTION OF THE DRAWINGS

FIG. 1 shows an example system and processing flow according to the present invention.

FIG. 2 shows an example method according to the present invention.

### DETAILED DESCRIPTION

Embodiments of the present invention will now be described in detail, by way of example only, with reference to the accompanying drawings in which identical or corresponding parts/features are provided with the same reference numerals in the figures.

An application or program interface to retrieve and display data from a data storage system for report files of an application program that generates such reports is described below. The interface is configured to be operational with general purpose or special purpose computing system environments or configurations, such as hand-held or laptop devices, personal computers, server computers, multiprocessor systems, microprocessor-based systems, set top boxes, programmable consumer electronics, network PCs, minicomputers, mainframe computers, distributed computing environments that include any of the above systems or devices, and the like.

The interface may be described as computer-executable instructions, such as program modules, being executed by a computer, e.g. hand-held device. The interface may also be practiced in distributed computing environments where tasks are performed by remote processing devices (server, etc.) that are linked to by the user's device through a communications network. Therefore, the program modules may be located in both local and remote computer storage media, e.g. memory.

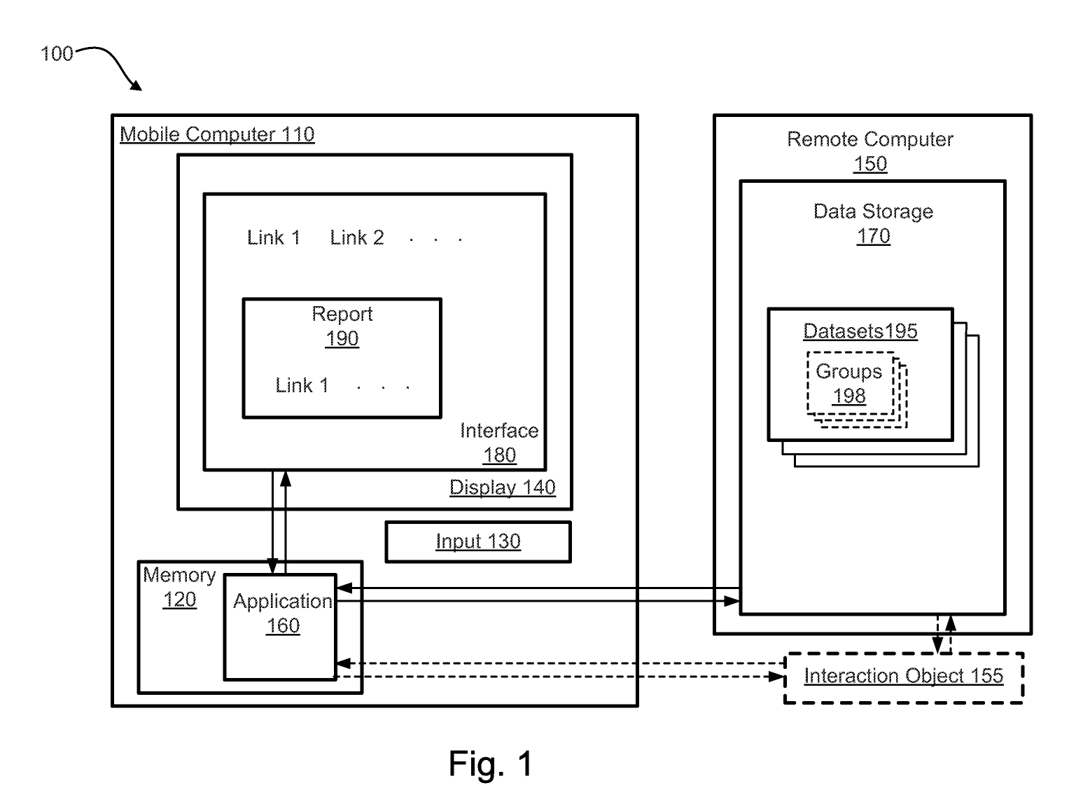

FIG. 1 shows an example computer system 100 for implementing the interface which includes a general purpose mobile computing device in the form of a mobile computer 110. Mobile computer 110 typically includes a variety of computer readable media (e.g. system memory 120) including both volatile and nonvolatile, removable and non-removable media implemented in any method or technology for storage of information such as computer readable instructions, data structures, program modules or other data.

A user may enter commands and information into the mobile computer 110 through input device 130 such as a keyboard, a microphone, a pointing device, or the like. A display 140 is provided for displaying the interface to the user although mobile computer 110 may also include other peripheral output devices such as speakers and printers.

The mobile computer 110 may operate in a networked environment using logical connections to one or more remote computers, such as a remote computer 150. The remote computer 150 may be a network PC connected via a local area network (LAN) and/or a wide area network (WAN), but may also include other networks. Networking environments are commonplace in offices, enterprise-wide computer networks, intranets and the Internet.

In such a networked environment, program modules accessed by the mobile computer 110, or portions thereof, may be stored in the memory storage device of a remote computer 150. For example, FIG. 1 illustrates an application program 150, residing on mobile computer 110 that could also be stored on remote computer 150. Furthermore, it will be obvious to one skilled in the art that any other means of establishing a communications link between the computers may be used.

Computer system environment 100 includes a data storage (e.g. financial/business) system 170 stored on remote computer 150. As shown in FIG. 1 computing system 100 includes an application program 160, such as a financial reporting program, which interfaces with the data storage system 170 such as financial or general ledger systems. The application program 160 interfaces with data storage system 170 through an application specific interface 180 depending upon the nature of the formatting used by data storage system 170 to store data or information. In particular, the application program 160 may interface with commercially available financial or general ledger systems that generate reports, like SAP® Crystal Reports®.

The data storage system 170 may include financial data or other data which is accessed through an interface. Different data storage systems have different data structures or formats requiring application specific interface 180 in order for the application program 160 to communicate with, and retrieve data from, the selected data storage system 170 which uses a particular format for storing data. The application program 160 may retrieve data from data storage 170 based upon user inputted queries. Application program 160 may then generate and display reports 190 (starting with top level summary reports and drilling up or down according to user input as explained below) based on the retrieved data from the data storage system 170. Therefore the application program 160 may include associated executable code to generate and display these reports according to a user's input.

The user interface 180 may include a functionality for displaying reports 190 by outputting them to an output device such as a display 140 shown in FIG. 1. Initially a user may select one or more dataset 195 from the datasets stored in data storage system 170 for viewing in a report 190. A top level report 190 is provided to the user showing only the summaries or totals for top level groups 198 of selected dataset 195. These groups 198 may be established according to filters selected by the user via interface 180 or may be already present in the dataset 195. For example, the selected dataset 195 may include groups 198 of data like “customer” or “product”. The user interface 180 includes a drilldown feature which generates a lower level report 190 corresponding to a selected item (e.g. customer) of the report 190. The lower level report 190 is activated (for example) by double clicking on a selected item (e.g. group 198) in top level report 190. The lower level report 190 displays summaries of the lower level groups 198 (e.g. subgroups) contained within the selected top level group 198 of top level report 190. This allows the user to “drill” into the data only at chosen locations, i.e. selected items. Drilling into a chosen item in the selected dataset 195 will cause the interface 180 to display summaries for the chosen top-level group 198, for example “product”. The drilldown feature is activated to retrieve transaction data for a selected item of a higher level report, such as “product”. The application program 160 then drills back to the data storage system 170 to retrieve more detailed data regarding the selected item “product” from the data storage system 170 for the selected dataset 195. In order to use the drilldown feature it may be necessary for the data storage system 170 to be open or running in the background.

Upon activation of the drilldown feature, application program 160 may drill back to the data storage system 170 to retrieve the requested data from the selected dataset 195 and generate a lower level report (displaying the requested data and including links for drilling deeper into the data) to be displayed to the user. The user may then select a specific item (group 198) in the lower level report and drill down further, for example a specific customer or product may be selected for further reporting. A new lower level report would be created which would display summaries for the selected lower level item (e.g. client A or product A) within the selected top level group 198. For a tree data structure, the lower level groups 198 may be referred to as “child nodes” of the higher level groups 198 to which they belong. The drill down process iteratively continues until the user arrives at a leaf node (any node of a tree that does not have child nodes) where the relevant data will be displayed in a report for the lowest level groups 198 in the dataset 195. The user may then navigate up the hierarchies of the groups 198 of dataset 195 in order to explore other groups 198 at any level of the selected dataset 195. Likewise the highest level report may be based on several selected datasets from data storage system 170 and the first drill down operation would then involve selection of one of the datasets for further exploration.

The interface 180 may communicate directly with the data storage system 170 or alternatively, the interface 180 may retrieve the data from the data storage system 170 through a remote interaction object 155 that may reside on remote computer 150. In particular, some financial systems or general ledgers expose their object model and in such cases the application program 160 may include an interface 180 that can directly access the data storage system 170. In other cases (due to firewall restrictions, slow mobile CPUs, etc.), application program 160 may rely on another remote application to retrieve requested data from data storage system 170, e.g. an interaction object 155 may be used to drill in to the data in data storage system 170. A remote application, such as interaction object 155, may also be responsible for converting the requested data into a format that is compatible with application program 160.

The application program 160 may be compatible with different financial programs or data storage systems with diverse formats and data structures. The data may be static, for example, the saved data in a Crystal Report or located in a document(s), or dynamic, that is, retrieved from a data source, for example, a relational database, in response to a query. In some embodiments, the data may be in SAP Crystal Reports format, or anther format suitable for report content, for example, HTML, XML with appropriate XSD to define filtering, sorting, groupings, sorting, and the like. As mentioned above, in order to interface with different data storage systems 170, a specific application interface 180 that is compatible with or configured to communicate or interface with each data storage system 170 is required. The data retrieved from data storage system 170 may then be converted to a format that facilitates viewing on modern mobile devices in view of the limitations of these devices as explained above, e.g. initial summary report with links for drilling down into the groups 198 of data the user desires to explore.

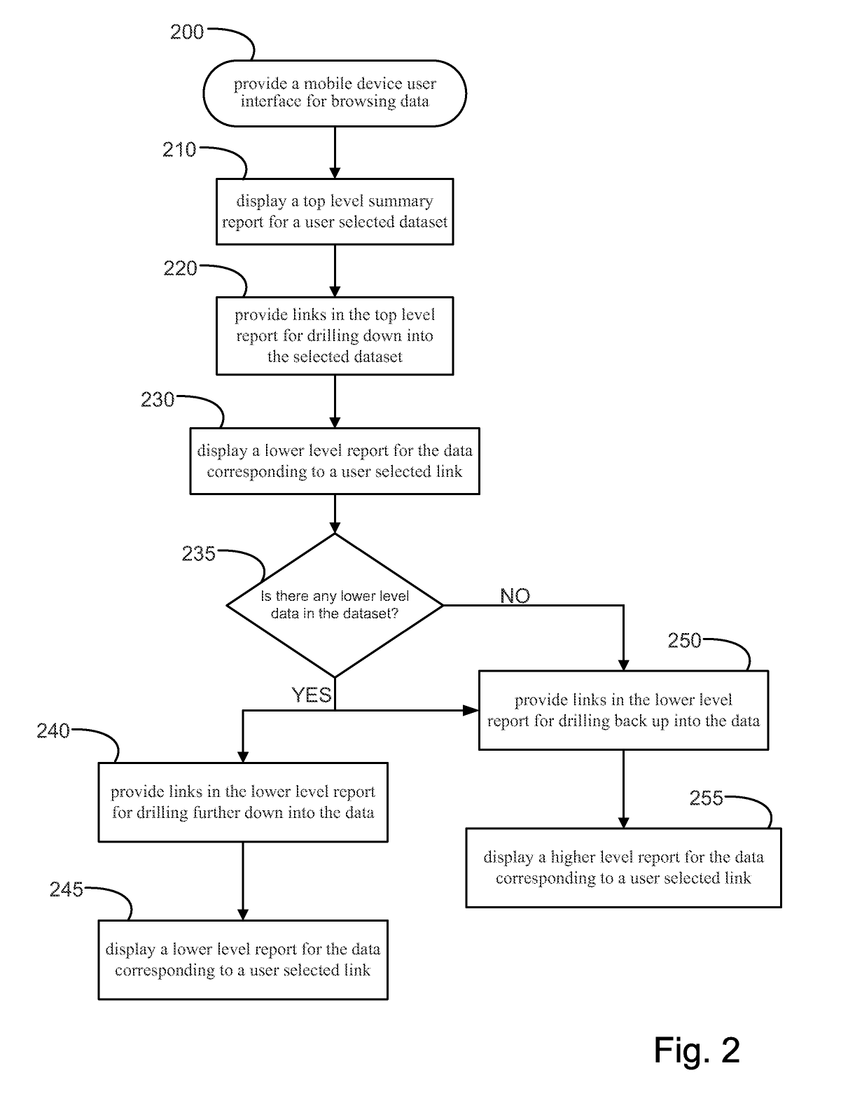

FIG. 2, illustrates an example method for retrieving and/or displaying data from the data storage system 170 on mobile computing devices like mobile computer 110. In step 200 a mobile device user interface 180 may be provided for browsing data stored on a remote data storage system 170. As explained above the application program 160 accessed by the user interface 180 to retrieve and/or display data from the data storage system 170 may reside on the mobile computing device (e.g. mobile computer 110) or on a remote computer, for example remote computer 150 that includes data storage system 170. In step 210 a top level report (e.g. report 190) grouping (as explained above the groups 198 may be determined according to filters selected by the user via interface 180 or may be already present in the dataset 195) and summarizing the data of a dataset 195 stored on the remote data storage system 170 is displayed (e.g. on display 140 of mobile computer 110) in response to a user selection (e.g. via input device 130 of mobile computer 110) of a link in user interface 180 corresponding to selected dataset 195. In step 220 links may be provided in the top level report for drilling down into at least one of the groups 198 of data (as grouped in step 210) of the selected dataset 195. In step 230 a lower level report 190 may be displayed grouping and summarizing the data of the group 198 corresponding to a user selected link in the top level report 190. In step 235 it may be determined if there are any lower level groups 198 of data within the selected group 198 corresponding to the user selected link in the top level report 190. If it is determined that there are no lower level groups 198 within the selected group 198 then the method proceeds to step 250 and if it is determined that there is at least one lower level group 198 within the selected group 198 then the method proceeds to step 240. In step 240 links may be provided in the lower level report 190 for drilling down into at least one of the lower level groups 198 of data contained in the higher level group 198 corresponding to the user selected link in the top level report 190. In step 245 a lower level report 190 may be displayed grouping and summarizing the data of a further lower level subgroup 198 corresponding to a user selected link in higher level report 190. In step 250 links may be provided in the lower level report 190 for drilling up into at least one of the higher level groups 198 of data containing the lower level group 198 corresponding to the user selected link in the top level report 190. In step 255 a higher level report 190 may be displayed grouping and summarizing the data of a higher level subgroup 198 corresponding to a user selected link in lower level report 190.

Furthermore, the method of the present invention may provide links in a report 190 for drilling down into at least one sub group 198 only if the at least one top level group 198 of report 190 contains any sub groups 198 of data to be displayed.

The present invention may be implemented, for example, using SAP Mobile BI which includes the ability to render “report” content provided in the CRF format mentioned above. Furthermore CRF format allows for the designation of drill down paths for report content that may be navigated by a user in either direction. Therefore the method may be practiced by an application program (e.g. application program 160) that generates CRF formatted content from data stored in a remote data storage system (e.g. data storage system 170). The stored data may be, for example, stored in a relational database or stored in reports generated via SAP Crystal Reports. The algorithm for generating the CRF content from Crystal Reports data may be simplified by the fact that Crystal Reports API includes a “totaller node” object which corresponds to a group of data in a Crystal Reports report. Therefore the top level data needed for the initial summary report displayed on a mobile computing device for a user selected Crystal Reports report may be based on the root “totaller node” corresponding to the selected Crystal Reports report. Then in a recursive step, if the root (or higher level) node contains any child nodes the totaller nodes for the child nodes are retrieved. The generation of CRF representing the reports data may be performed during the “totaller node” hierarchy traversal or afterwards. In this way a higher level CRF formatted object corresponding to a “totaller node” of a selected Crystal Reports report will include drill down links for viewing all of the CRF objects corresponding to each of the child nodes of the “totaller node”.

Embodiments of the present invention are described in the context of a fully functional computer system, however those skilled in the art will appreciate that modules of the present invention are capable of being distributed in a variety of forms across a plurality of systems. Embodiments consistent with the invention may also include one or more programs or program modules on different computing systems running separately and independently of each other, while in their entirety being capable of performing business transactions in a large enterprise environment or in a “software on demand” environment. These programs or program modules may be contained on signal bearing media that may include: recordable type media such as floppy disks and CD ROMS, and transmission type media such as digital and analog communication inks, including wireless communication links.

The foregoing description is not exhaustive and does not limit embodiments of the invention to the precise forms disclosed. Modifications and variations are possible in light of the above teachings or may be acquired from the practicing embodiments consistent with the invention. For example, some of the described embodiments may include software and hardware, but some systems and methods consistent with the present invention may be implemented in software or hardware alone. Additionally, although aspects of the present invention are described as being stored in memory, one skilled in the art will appreciate that these aspects can also be stored on other types of computer-readable media, such as secondary storage devices, for example, hard disks, floppy disks, or CD-ROM; the Internet or other propagation medium; or other forms of RAM or ROM.

We claim:

1. A method for retrieving and displaying data from a data storage system on a mobile computing device, the method comprising:
providing a user interface on the mobile device for browsing data stored on a remote data storage system;
in response to a user selection of a dataset stored on the remote data storage system retrieving data associated with the selected dataset from the remote data storage system; and
displaying on the mobile device a top level report grouping and summarizing the data of the selected dataset;
wherein the top level report includes links for drilling down into at least one of the groups of data of the selected dataset.

2. The method of claim 1, further comprising:
converting the data associated with the selected dataset to a format that is compatible with the user interface after it is retrieved from the remote data storage system.

3. The method of claim 1, wherein the data associated with the selected dataset is retrieved via a remote application that interfaces with the remote data storage system.

4. The method of claim 2, wherein the data associated with the selected dataset is converted to a format that is compatible with the user interface by a remote application that interfaces with the remote data storage system.

5. The method of claim 1, wherein the groupings of the data of the selected dataset are determined according to at least one of: a user selection of filters and groupings already present in the selected dataset.

6. The method of claim 1, further comprising:
in response to a user selection of a link in the top level report, displaying a lower level report grouping and summarizing the data of the group corresponding to the selected link.

7. The method of claim 6, wherein the lower level report includes links for drilling down into at least one of the groups of data within the group corresponding to the selected link.

8. The method of claim 7, wherein the lower level report includes links for drilling down into at least one of the groups of data within the group corresponding to the selected link only if the at least one group contains any more data to be displayed.

9. The method of claim 7, wherein the lower level report includes links for drilling up into at least one of the groups of data containing the group corresponding to the selected link.

10. A computer-readable medium having stored thereon instructions adapted to be executed by a processor, the instructions which, when executed, cause the processor to perform a method for retrieving and displaying data from a data storage system on a mobile computing device, comprising:
providing a user interface on the mobile device for browsing data stored on a remote data storage system;
in response to a user selection of a dataset stored on the remote data storage system retrieving data associated with the selected dataset from the remote data storage system; and
displaying on the mobile device a top level report grouping and summarizing the data of the selected dataset;
wherein the top level report includes links for drilling down into at least one of the groups of data of the selected dataset.

11. The computer-readable medium of claim 10, further comprising:
converting the data associated with the selected dataset to a format that is compatible with the user interface after it is retrieved from the remote data storage system.

12. The computer-readable medium of claim 10, wherein the data associated with the selected dataset is retrieved via a remote application that interfaces with the remote data storage system.

13. The method of claim 11, wherein the data associated with the selected dataset is converted to a format that is compatible with the user interface by a remote application that interfaces with the remote data storage system.

14. The computer-readable medium claim 10, wherein the groupings of the data of the selected dataset are determined according to at least one of: a user selection of filters and groupings already present in the selected dataset.

15. The computer-readable medium of claim 10, further comprising:
in response to a user selection of a link in the top level report, displaying a lower level report grouping and summarizing the data of the group corresponding to the selected link.

16. The computer-readable medium of claim 15, wherein the lower level report includes links for drilling down into at least one of the groups of data within the group corresponding to the selected link.

17. The computer-readable medium of claim 16, wherein the lower level report includes links for drilling down into at least one of the groups of data within the group corresponding to the selected link only if the at least one group contains any more data to be displayed.

18. The computer-readable medium of claim 16, wherein the lower level report includes links for drilling up into at least one of the groups of data containing the group corresponding to the selected link.

19. A system for retrieving and displaying data from a data storage system on a mobile computing device, comprising:
at least one remote data storage system including a processor and memory; and
a mobile computing device including a processor, memory and a display; and
an application program running on the mobile computing device and providing a user interface for browsing data stored on the remote data storage system;
wherein, the system is configured to:
in response to a user selection of a dataset stored on the remote data storage system retrieve data associated with the selected dataset from the remote data storage system; and
display on the mobile device a top level report grouping and summarizing the data of the selected dataset;
wherein the top level report includes links for drilling down into at least one of the groups of data of the selected dataset.

20. The system of claim 19, further configured to:
convert the data associated with the selected dataset to a format that is compatible with the user interface after it is retrieved from the remote data storage system.

21. The system of claim 19, further comprising:
a remote application that interfaces with the remote data storage system wherein the data associated with the selected dataset is retrieved via the remote application.

22. The system of claim 20, further comprising:
a remote application that interfaces with the remote data storage system wherein the data associated with the selected dataset is converted to a format that is compatible with the user interface by the remote application.

23. The system of claim 19, further configured to determine the groupings of the data of the selected dataset are according to at least one of: a user selection of filters and groupings already present in the selected dataset.

24. The system of claim 19, further configured to:
in response to a user selection of a link in the top level report, displaying a lower level report grouping and summarizing the data of the group corresponding to the selected link.

25. The system of claim 24, further configured to include links in the lower level report for drilling down into at least one of the groups of data within the group corresponding to the selected link.

26. The system of claim 25, further configured to include links in the lower level report for drilling down into at least one of the groups of data within the group corresponding to the selected link only if the at least one group contains any more data to be displayed.

27. The computer-readable medium of claim 25, further configured to include links in the lower level report for drilling up into at least one of the groups of data containing the group corresponding to the selected link.
